(19) United States
(12) Patent Application Publication
(10) Pub. No.: US 2008/0122601 A1
(43) Pub. Date: May 29, 2008

(54) Onboard Indicator Needle with Luminescent Lighting

(75) Inventor: Joel Fournier, Cergy (FR)

Correspondence Address: FOLEY AND LARDNER LLP;SUITE 500, 3000 K STREET NW, WASHINGTON, DC, 20007, US

(73) Assignee: Johnson Controls Automotive Electronics

(21) Appl. No.: 10/565,060

(22) PCT Filed: Jul. 13, 2004
(86) PCT No.: PCT/FR04/01837

§ 371 Date: Jan. 22, 2008

(30) Foreign Application Priority Data
Jul. 16, 2003 (FR) 03/08676

(51) Int. Cl. B60Q 1/00

(52) U.S. Cl. 340/438; 340/815.4

(57) ABSTRACT

The invention pertains to an onboard indicator (1) with luminous needle (10) , which indicator is mounted on a dashboard electronic card (21), the needle comprising an arm movable in rotation with a light source (13) and the card a source (22) for energizing the light source. It is characterized in that the light source comprises a support of flexible material (30) with a first part (30′) covered with a photophore substance (13) subjected to an electric voltage from the energizing source to which it is linked electrically by a flexible electrical link (30, 31, 32) formed by a second part (30″) of the insulating flexible support (30) serving as substrate for at least two conducting tracks (31, 32).

The solution of the invention makes it possible to produce a very flat indicator with a minimum of components.

### CROSS-REFERENCE TO RELATED PATENT APPLICATIONS

The present Application is a National Stage of Application PCT/EP2004/01837 entitled, “Onboard Indicator Needle with Luminescent Lighting” filed on Jul. 13, 2004 which published under PCT Article 21(2) on Jan. 27, 2005 as WO 2005/008185 A2 in the French language, which claims priority to French Patent Application No. 03/08676 filed on Jul. 16, 2003, the disclosures of which are incorporated herein by reference in their entirety.

### BACKGROUND

The invention relates to the field of onboard indicators with luminous needles for motor vehicle dashboards and more particularly the mounting and the connection of these luminous needles.

Luminous needles exist on numerous motor vehicle dashboard indicator dials. They are designed to indicate, as a function of their angular swing over a determined sector of the dial, a physical quantity relating to the vehicle.

The luminous needles may, on the basis of a fixed light source close to their rotational spindle, receive their light by virtue of light guides provided in their hub and be arranged so as to diffuse the light over their length. In this case, in their rotational motion to indicate a physical quantity, the light source remains fixed and there is no problem with its electrical energizing (or ability to receive power). However, this mode of lighting requires a hub of complex design and the brightness of the needle is not optimal.

Luminous needles may also contain their own light source, which is then energized electrically by conductors provided in the hub. This method eliminates the drawback above, but the electrical link between the two sources is dynamic since the light source turning with the needle and the electrical energizing source is fixed on the electronic card of the dashboard.

The proposal has been contemplated, for example in U.S. Pat. No. 5,797,345, to mount sliding contacts linked to the light source on the hub of the needle and fix the contacts linked to the energizing source in contact with the sliding contacts.

This second solution has the drawback however of requiring the presence of sliding contacts which may be prone to wear by friction and mishandling even to the extent of cutting off the energy supply to the light source. Additionally, the complexity of the mounting of the electrical circuits gives rise to additional cost considerations.

### SUMMARY

The present vehicle dashboard proposes, for this second solution, an improvement aimed at eliminating the presence of any sliding contact while ensuring simple mounting of the needle.

In one exemplary embodiment, an onboard indicator includes a luminous needle. The indicator is mounted on a dashboard electronic card and the needle comprises an arm rotatable with a light source. The dashboard electronic card is configured to provide an energizing source for the light source and the light source comprises a support composed of flexible material having a first part and second part. The first part is covered with a photophore substance and is configured to be subjected to an electric voltage from the energizing source. The first part is linked electrically by a flexible link formed by the second part of the flexible support and wherein the second part serves as substrate for at least two conducting tracks.

In another exemplary embodiment, a vehicle dashboard comprises a dashboard electronic card, an indicator mounted with respect to the dashboard electronic card, a needle mounted with respect to the indicator and configured to illuminate. The needle comprises a rotatable arm having a light source and the dashboard electronic card is configured to provide electric power to the light source. A flexible support has a first part and a second part, the first part having a photophore substrate. The first part is flexible and configured to receive an electronic voltage from the dashboard electronic card. At least two conductive tracks are coupled to the second part and the first part is configured to electrically link the second part and the dashboard electronic card.

In yet another exemplary embodiment, is a method of operating a needle of an onboard indicator suitable for a dashboard of a motor vehicle. The needle rotates with respect to the dashboard. The method comprises: providing an electronic card with the electronic card coupled to the onboard indicator; providing a light source, with the light source rotatable and the electronic card configured to power the light source through at least two conductive tracks; providing an electrically conductive support with pins mounted with respect to the electronic card (the pins are configured to be in contact with at least one of the two conductive tracks); providing a flexible electrical link between the conductive tracks and the electrically conductive support; and powering the light source from the electronic card through the flexible electrical link.

For this purpose, the vehicle dashboard relates to an onboard indicator with luminous needle in which indicator is mounted on a dashboard electronic card. The needle comprises an arm movable in rotation with a light source and the electronic card a source for energizing the light source. The indicator has a light source which comprises a first part of a support of flexible material covered with a photophore substance subjected to an electric voltage from the energizing source which it is linked electrically by a flexible electrical link (or flexible link) formed by a second part of the insulating flexible support. The second part of the insulating flexible support serves as substrate for at least two conducting tracks.

In particular, the second part of the flexible support is attached to at least two pins so that can each be fitted into an electrical contact attached to the electronic card. Each pin is in contact with one of the two conducting tracks.

When the indicator is activated (or called on to indicate a physical quantity), the needle pivots about its spindle and the electrical link unwinds around the hub of the needle. Therefore, the need for a sliding contact has been eliminated.

The needle comprises a minimum of components to be mounted with the space of the vehicle dashboard.

Preferably, at its end attached to the electronic card, the flexible film is attached to at least two pins that each can be fitted into an electrical contact on the electronic card. Each pin is in contact with one or other of the two conducting tracks.

This arrangement allows mounting of the indicator in a single operation by plugging in the electrical connections of the light source into the needle with the energy supply.

Advantageously, the pins are assembled on a support of pins which can be secured into a housing thereby retaining the support provided in the needle to facilitate mounting.

Advantageously, the pins support retaining housing and the electrical contacts of the electronic card are arranged so as to enable the pins to be plugged into the contacts in the mounted position of the indicator. To avoid the colliding of the housing for retaining the pins support with the pins support the indicator is positioned not to block the operation thereof or hinder the swing of the indicator during operation.

Advantageously still, the pins support and the retaining housing are arranged so as to be detached upon the powering-up of the motor of the indicator.

### BRIEF DESCRIPTION OF THE DRAWINGS

The invention will be better understood by virtue of the following description of exemplary embodiments of an onboard indicator and of the accompanying drawings:

FIG. 1 represents a sectional profile view of the needle of the onboard indicator according to one exemplary embodiment of the vehicle dashboard.

FIG. 2 represents a view from below of the needle in the same position, the electronic card and the dial being removed, according to one exemplary embodiment of the vehicle dashboard;

FIG. 3 represents a perspective view of the pins support according to one exemplary embodiment of the vehicle dashboard;

FIG. 4 represents a sectional profile view of the needle of the onboard indicator of the vehicle dashboard, according to one exemplary embodiment of the vehicle dashboard; and

FIG. 5 represents a view from below of the needle in the same position as FIG. 4 according to one exemplary embodiment of the vehicle dashboard.

### DETAILED DESCRIPTION

With reference to FIG. 1, the onboard indicator 1 of the vehicle dashboard comprises a dial 14, made of polycarbonate materials for example, bearing graduations indicative of physical quantities relating to the progress of the vehicle. In the centre of the onboard indicator an opening 40 (or orifice) is defined through which there passes a hub 15 attached to a spindle 19 of a motor 20. The motor may be a stepper motor for example mounted on an electronic card 21.

The hub 15 is extended by a needle 10 running towards the graduations of the dial 14 through an arm 11 which is at least partially covered by a transparent fairing 12 (or smooth surface). The stepper motor 20 is arranged so as to make the needle pivot as a function of the physical quantity to be displayed on the dial.

An adhesive is utilized between the visible part of the arm 11 and the fairing 12 and applied onto the arm in which case a first part 30′ of a support is partially covered with a layer of photophore material. In one exemplary embodiment the material is an electroluminescent ink applied over a determined area so as to form the pointer of the needle.

According to an exemplary embodiment of the onboard indicator 1 includes a support 30 which runs beyond the arm 11 of the needle 10 through a second band-shaped part 30″ extending along the hub 15. The support 30 is free to pass through the dial 14 via the opening 40 and travel around the hub 15 along an ‘S’ shaped spiral surrounding the hub underneath the dial. To accomplish this, the support 30 is folded over on itself at 90° at approximately the height of the hub, forming a fold 45.

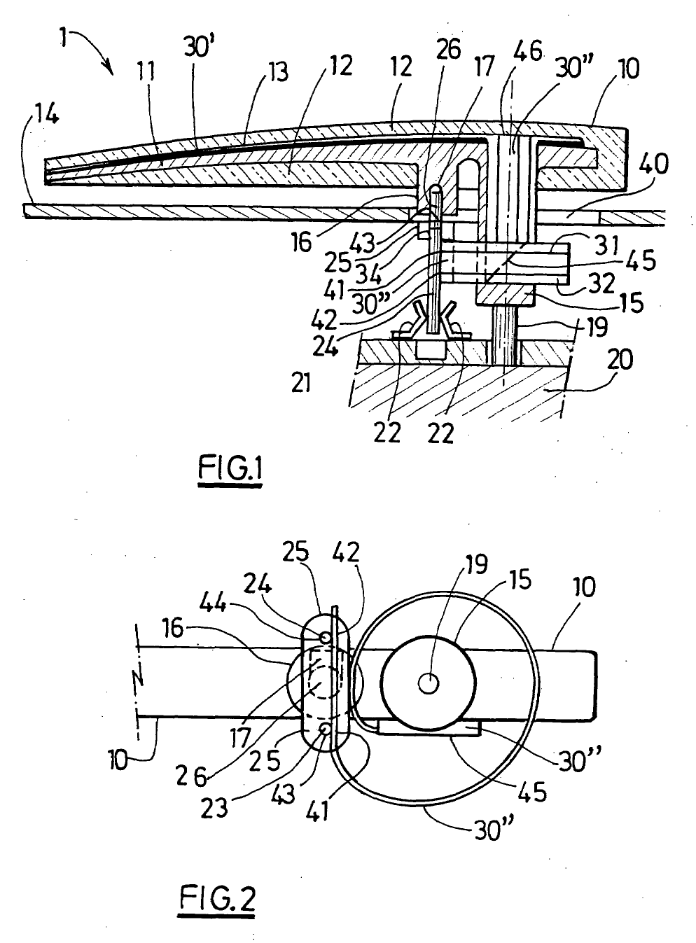

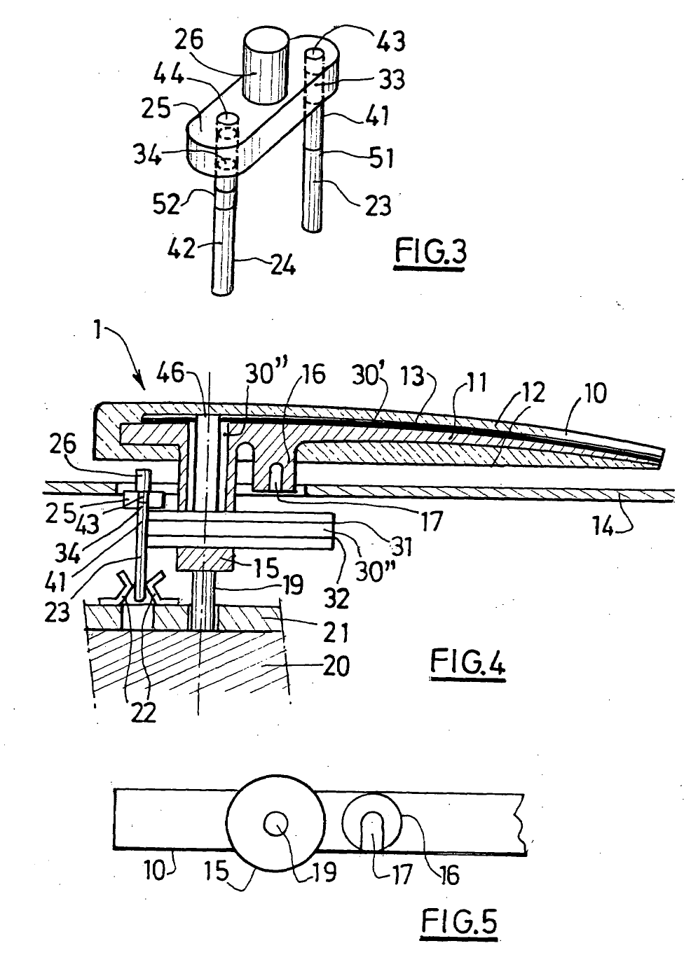

The support 30 is electrically insulating. The second part of the support comprises two parallel conducting tracks 31 and 32 linked to either side of the pointer so as to energize it electrically in a suitable manner and to enable the pointer to extend without interruption up to its free end. On the first part 30′ of the support 30 these two conducting tracks act as electrodes over the entire length of the needle or at least its visible part and enables the excitation of the electroluminescent ink. One of the tracks 31 abuts contact 41 with a pin 23 attached to the support 30, and the other track 32 abuts contact 42 with another pin 24 which is also attached to the support 30. The contacts 41 and 42 are fairly distant from the support 30 so as to provide for mounting. In one exemplary embodiment, as illustrated in FIG. 2, the ‘S’ shaped spiral is formed by the band 30″ around the hub 15 and the layout of the pins (23 and 24) attached to its free end. As the band 30″ is flexible, the pins 23, 24 are held in parallel with respect to one another by means of a pins support 25, as is illustrated in FIG. 3.

The pin support 25 comprises a central spigot 26, and two equidistant holes (or apertures) 43 and 44 in which the ends 33 and 34 of the pins 23 and 24 are inserted. The pins 23, 24 run out of the support 25 away from the central spigot 26.

The band 30″ is glued to the pins 23 and 24. In one exemplary embodiment, in order to avoid an electrical short-circuit, insulating bushings 51 and 52 have been disposed on the pins 23 and 24 to insulate the pin 23 from the track 32 and to insulate pin 24 from the track 31. Thus the pin 23 is in electrical contact at 41 only with the track 31 and the pin 24 is in electrical contact at 42 only with the track 32.

Under the needle 10, a spigot 16 has been provided in such a way as to be fairly close to the hub 15 so as to pass into the opening 40 in which a housing 17 retaining the support 25 of the pins 23 and 24 has been made.

The spigot 16 of the needle 10 is of such a length that when the spigot 26 of the pin support 25 is engaged in the housing 17 the pins 23 and 24 can be plugged into the electrical contacts 22 attached to the electronic card 21. The housing 17 is arranged, as in FIG. 5, so as to retain the spigot 26 by lateral snap-fastening.

When in a mounted position of the needle, the spigots 16 and 26 are aligned and the pins are plugged into the contacts 22, the needle is situated outside of its operating range on the dial. Consequently, the length of the band 30″ is sufficient to allow the needle to pivot not only over the entirety of the operating range, but also beyond the mounted position of the needle.

During normal operation of the indicator 1, as illustrated in the exemplary embodiment of FIG. 4, the needle 10 is in an operating position situated somewhere in a sector determined by its swing about its spindle 19. In general, the swing covers an angle of 180° or more. In this case, the support 25 of the pins 23, 24, which are plugged into the contacts 22, is not situated in the sector. The support 25 remains out of reach of the spigot 16 of the needle 10 thereby not hindered in its motion.

For the mounting of the needle, the spigot 26 of the support 25 of the pins 23, 24 is engaged into the housing 17 and the pins are plugged into the contacts 22 . Simultaneously the hub 15 is plugged into the spindle 19 of the motor 20. The needle is then placed in a mounted position as in FIG. 1, outside of the sector determined by its sweep while operating.

For placement in the operating position, the needle 10 is forced, to turn, manually or automatically by starting up the motor 20, so as to bring the needle into the sector. Through this action, the spigot 26 is forced to leave the spigot 16.

During operation, the electrodes of the first part 30′ of the support provide for the excitation of the photophore material which becomes luminous. Regardless of the position of the needle, the energizing of the first part is provided for by the electrodes on the second part which by virtue of the flexibility of the support 30″ follow the motion thereof while remaining connected to the source.

It should be understood that the construction and arrangement of the elements of the onboard indicator in the exemplary embodiments are illustrative only. Although several embodiments of the onboard indicator have been described in detail in this disclosure, many modifications are possible without materially departing from the novel teachings and advantages of the subject matter recited in the claims. Accordingly, all such modifications are intended to be included within the scope of the present onboard indicator as defined in the appended claims. Unless specifically otherwise noted, the claims reciting a single particular element also encompass a plurality of such particular elements. Moreover, claims reciting that one element is coupled to another should be interpreted to mean that the elements are selectively coupled to each other and may be uncoupled or disconnected at a ny point. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

1-5. (canceled)

6. An onboard indicator with luminous needle, wherein the indicator is mounted on a dashboard electronic card, the needle comprising:
an arm rotatable with a light source, the dashboard electronic card configured to provide an energizing source for the light source, the light source comprising a support composed of flexible material having a first part and second part;
wherein the first part is covered with a photophore substance and is configured to be subjected to an electric voltage from the energizing source, and wherein the first part is linked electrically by a flexible link formed by the second part of the flexible support and wherein the second part serves as substrate for at least two conducting tracks.

7. The indicator of claim 6, wherein the second part of the flexible support is attached to at least two pins configured to be fitted into an electrical contact, wherein the electrical contact is attached to the dashboard electronic card, and wherein each pin is configured to be in contact with one of the at least two conducting tracks.

8. The indicator of claim 7, wherein the pins are assembled on a pins support, the pins support configurable to secure to a housing, provided in the luminous needle, and configured to retain the pins support.

9. The indicator of claim 8, wherein the housing and the electrical contacts of the dashboard electronic card are configured to enable the pins to plug into the electrical contacts, and wherein the electrical contacts are configured to avoid collision with the housing during operation of the luminous needle.

10. The indicator of claim 9, wherein the pins support and the housing are configured to detach when a motor of the indicator powers up.

11. The indicators of claim 7, wherein the light source is configured to rotate with the luminous needle, and wherein the conducting tracks are configured to at least partially surround the light source so as to remain in electrical contact with the light source while the needle is rotating.

12. The indicator of claim 11, wherein the conducting tracks are configured in parallel with respect to each other, and wherein the conducting tracks are configured to link to either side of the needle so as to energize the light source and to enable the needle to extend without interruption up to its free end.

13. The indicator of claim 8, wherein the pins support and the housing are configured to detach when a motor of the indicator receives power.

14. A vehicle dashboard, comprising:
a dashboard electronic card;
an indicator mounted with respect to the dashboard electronic card;
a needle mounted with respect to the indicator and configured to illuminate; the needle comprising a rotatable arm comprising a light source, the dashboard electronic card configured to provide electric power to the light source;
a flexible support, comprising a first part and a second part, the first part having a photophore substrate, the first part configurable to be flexible and to receive an electronic voltage from the dashboard electronic card; and
at least two conductive tracks coupled to the second part, wherein the first part is configured to electrically link the second part and the dashboard electronic card.

15. The indicator of claim 12, wherein the second part of the flexible support is attached to at least two pins configured to be fitted into an electrical contact, wherein the electrical contact is coupled to the dashboard electronic card, and wherein each pin is configured to be in electrical contact with one of the at least two conducting tracks.

16. The indicator of claim 12, wherein the at least two pins are insulated through bushings, and wherein a first pin is insulated from a second conducting track by a first bushing and a second pin is insulated from a second conducting track by a second bushing.

17. The indicator of claim 16, wherein the pins are assembled on a pins support and the pins support configurable to secure to a housing, and wherein the housing is configured to retain the pins support.

18. The indicator of claim 17, wherein the housing and the electrical contacts of the dashboard electronic card are configured to enable the pins to plug into the electrical contacts, and wherein the electrical contacts are configured to avoid collision with the housing during operation of the needle.

19. The indicator of claim 18, wherein the pins support and the housing are configured to detach when a motor of the indicator receives power.

20. The indicators of claim 15, wherein the light source is configured to rotate with the needle, and wherein the conducting tracks are configured to at least partially surround the light source so as to remain in electrical contact with the light source while the needle is rotating.

21. The indicator of claim 20, wherein the conducting tracks are configured in parallel with respect to each other, and wherein the conducting tracks are configured to link to either side of the needle so as to energize the light source and to enable the needle to extend without interruption up to its free end.

22. The indicator of claim 15, wherein the pins support and the housing are configured to detach when a motor of the indicator powers up.

23. A method of operating a needle of an onboard indicator suitable for a dashboard of a motor vehicle, wherein the needle rotates with respect to the dashboard, comprising:
providing an electronic card, the electronic card configured to couple to the onboard indicator;
providing a light source, the light source rotatable and the electronic card configured to power the light source through at least two conductive tracks;
providing an electrically conductive support with pins mounted with respect to the electronic card, the pins configured to be in contact with at least one of the two conductive tracks;
providing a flexible electrical link between the conductive tracks and the electrically conductive support; and
powering the light source from the electronic card through the flexible electrical link.

24. The method of claim 23, further comprising:
rotating the needle with respect the electronic card; and
fixing the electrically conductive support with respect to the dashboard.

25. The method of claim 23, further comprising:
providing a pins support by which the pins are coupled; and
detaching the pins support and the housing when a motor of the onboard indicator receives power.
